(19) United States
(12) Patent Application Publication
(10) Pub. No.: US 2002/0090019 A1
(43) Pub. Date: Jul. 11, 2002

(54) Temperature sensor

(76) Inventors: H. -Arno Marto, Ludwigsburg (DE); Heiner Lehmann, Ludwigsburg (DE); Erich Berdel, Ludwigsburg (DE)

Correspondence Address: NIXON PEABODY, LLP, 8180 GREENSBORO DRIVE, SUITE 800, MCLEAN, VA, 22102, US

(21) Appl. No.: 10/011,430

(22) Filed: Dec. 11, 2001

(30) Foreign Application Priority Data
Dec. 13, 2000 (DE) 100 62 041.8

(51) Int. Cl. G01K 7/16

(52) U.S. Cl. 374/185; 338/25

(57) ABSTRACT

A temperature sensor is provided which includes a measurement element, which changes its electrical resistance when the temperature changes. The measurement element is located in a protective sleeve, which may be provided with openings. A terminal-side area of the measurement element including its terminals and the surrounding area of the protective sleeve is potted in a temperature-resistant, electrically nonconductive material. The terminals are connected directly to two conductors within a jacketed tube.

### BACKGROUND OF INVENTION

1. Field of the Invention

The invention relates to a temperature sensor, especially a temperature sensor for temperatures above 600° C.

2. Description of Related Art

In temperature measurement technology, temperature sensors are often used for actual temperature measurement or to produce a temperature-dependent control signal. When these temperature sensors are used at high temperatures, especially above 600° C., these temperature sensors are composed of many components which require comparatively complex construction and connection technology. Also, at the same time, the electrical contacts are highly loaded by the high temperatures and possibly by the corrosive environment so that both factors can cause malfunctions. This is perceived as a disadvantage in this technical field.

### SUMMARY OF THE INVENTION

One object of the present invention is to make available a temperature sensor, especially for use at high temperatures, and especially above 600° C., while eliminating the disadvantages known from the prior art.

Another object of the present invention is to provide a sensor having a simple structure which is easy to produce and offers higher operational reliability than the temperature sensors known beforehand.

The above objects along with other objects are achieved by providing a temperature sensor comprising a protective sleeve and a measurement element having an electrical resistance which changes with a change in temperature. The measurement element is positioned in the protective sleeve and includes terminals located on a terminal-side area of the measurement element for connection directly to two conductors within a jacketed tube. The terminal-side area, the terminals and a surrounding area of the protective sleeve are potted in a temperature-resistant, electrically nonconductive material. The protective sleeve may include openings and the terminals of the measurement element may be connected directly to the conductors by one of soldering, welding and crimping. The measurement element may include one of a negative temperature coefficient of resistance (NTC) material and a positive temperature coefficient of resistance (PTC) material. The measurement element may be one of a flat resistor and round resistor made from one of platinum and a platinum alloy, mounted on a ceramic carrier. The measurement element may be fixed by a protective wire braiding for mechanical stabilization. An attachment device may be provided for interaction with a union nut on the jacketed tube. The attachment device may include a mounting sleeve having an outside thread. The terminal-side area of the measurement element, including the terminals, contact points and the two conductors, may be potted within the protective sleeve in one of glass and ceramic. The measurement element may be partially potted and a unit comprising the jacketed conductor tube, the attachment means and the protective sleeve may be formed integrally with the partially potted measurement element. The entire measurement element may be potted completely in one of glass and ceramic. Alternative to partial potting, the measurement element may be potted in the protective sleeve which is filled completely with one of glass and ceramic.

### BRIEF DESCRIPTION OF THE DRAWINGS

FIG. 1 is a side partial cross sectional view of the temperature sensor of the present invention; and

FIG. 2 is a side partial cross sectional view of a second embodiment of the temperature sensor of the present invention having a protective sleeve.

### DETAILED DESCRIPTION OF THE INVENTION

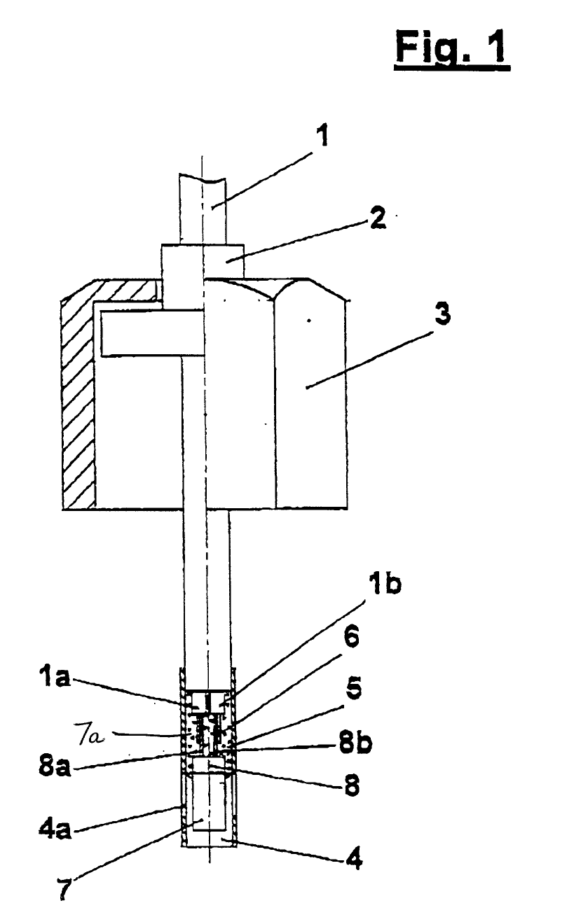

FIG. 1 shows one preferred embodiment of the temperature sensor of the present invention including a jacketed conductor tube 1 in which two conductors 1a and 1b, insulated from one another, are routed. The conductors 1a and 1b emerging from the jacketed conductor tube 1 are connected to terminals 8a and 8b of a measurement element 7. This measurement element 7 consists preferably of a NTC or PTC material, and preferably of platinum or a platinum alloy on a ceramic carrier. In the area of the measurement element 7, the jacketed conductor tube 1 is securely connected to a protective sleeve 4 which can optionally have openings 4a. In special applications, however, the protective sleeve 4 can be closed all around.

A terminal-side area 8 of the measurement element 7 is potted in a temperature-resistant, electrically nonconductive material 5, preferably glass or ceramic. A longer measurement element 7 can also be fixed with a high temperature-resistant, high quality steel braid for mechanical stabilization.

On the other end of the jacketed conductor tube 1, there are mounting means 2, preferably in the form of a mounting sleeve 2 fixed on the jacketed conductor tube 1, by which the temperature sensor can be attached at its application site via a union nut 3. Alteratively, the mounting sleeves 2 can have an outside thread for turning into a threaded hole at the site where the temperature sensor is used.

The temperature sensor of the present invention is especially suited for use at temperatures above 600° C. By means of its structure, it can be easily produced and mounted, making production and mounting simpler and more economical. At the same time, increased operating reliability is achieved since measurement element 7, the conductors 1a and 1b, contact points 6 and the terminals 8a and 8b are effectively protected against mechanical and/or chemical damage.

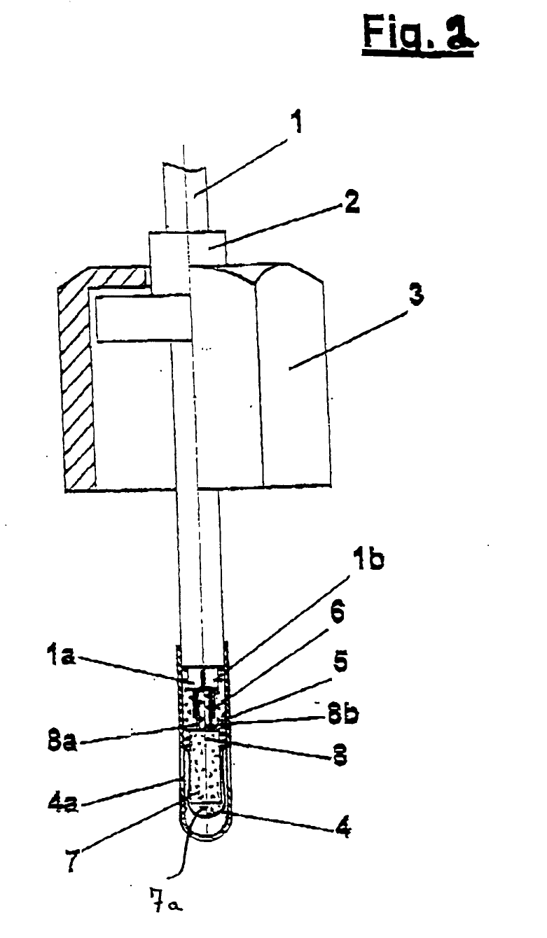

It has now been found that the essentially open measurement element can moreover be easily protected against environmental effects as well as damage during production of the temperature sensor of the present invention if a terminal-side area 8 of measurement element 7 including terminals 8a, 8b is potted completely in glass or ceramic 7a (FIG. 1) in the surrounding area of the protective sleeve 4. This compact unit can be surrounded by the protective sleeve 4, as is shown in the attached FIG. 2. But it is also conceivable for measurement element 7, optionally together with the terminals, to be potted within the protective sleeve or tube 4 as the sleeve 4 is completely filled with glass or ceramic 7a.

We claim:

1. A temperature sensor, comprising:
a protective sleeve;
a measurement element having an electrical resistance which changes with a change in temperature, said measurement element positioned in said protective sleeve and including terminals located on a terminal-side area of said measurement element for connection directly to two conductors within a jacketed tube, wherein said terminal-side area, said terminals and a surrounding area of said protective sleeve are potted in a temperature-resistant, electrically nonconductive material.

2. The sensor of claim 1, wherein said protective sleeve includes openings.

3. The sensor of claim 1, wherein said terminals of said measurement element are connected directly to the conductors by one of soldering, welding and crimping.

4. The sensor of claim 1, wherein said measurement element includes one of a NTC material and a PTC material.

5. The sensor of claim 4, wherein said measurement element is one of a flat resistor and a round resistor made from one of platinum and a platinum alloy, mounted on a ceramic carrier.

6. The sensor of claim 1, wherein said measurement element is fixed by a protective wire braiding for mechanical stabilization.

7. The sensor of claim 1, further including an attachment means for interaction with a union nut on said jacketed tube.

8. The sensor of claim 7, wherein attachment means includes a mounting sleeve having an outside thread.

9. The sensor of claim 1, wherein said terminal-side area of said measurement element, including said terminals, contact points and said two conductors, are potted within said protective sleeve in one of glass and ceramic.

10. The sensor of claim 7, wherein said measurement element is partially potted and a unit comprising said jacketed conductor tube, said attachment means and said protective sleeve is formed integrally with said partially potted measurement element.

11. The sensor of claim 1, wherein the entire measurement element is potted completely in one of glass and ceramic.

12. The sensor of claim 1, wherein said measurement element is potted in said protective sleeve which is filled completely with one of glass and ceramic.
